(19) United States
(12) Patent Application Publication
(10) Pub. No.: US 2025/0165961 A1
(43) Pub. Date: May 22, 2025

(54) CORRELATION USING DETERMINISTIC DATA

(71) Applicant: Rotomaire, Inc., Holmdel, NJ (US)

(72) Inventors: Wilfried Schobeiri, Chicago, IL (US); Parker Noren, Stamford, CT (US); David Laverty, Norwalk, CT (US)

(21) Appl. No.: 18/511,647

(22) Filed: Nov. 16, 2023

(51) Int. Cl. G06Q 20/38; G06Q 20/36; H04L 9/32

(52) U.S. Cl. CPC G06Q 20/382; G06Q 20/363; G06Q 20/383; H04L 9/3213; G06Q 2220/00

(57) ABSTRACT

Methods, systems, and apparatus, including computer programs encoded on computer storage media, for transaction correlation. A method includes receiving first data representing a first digital transaction, the first data including: a first token associated with a first originator of the digital transaction; and a first character string associated with a first user; generating a first container represented by a second token, the first container being associated with the first originator and the first user; storing the first data in the first container; receiving second data representing a second digital transaction; determining that the second digital transaction is associated with at least one of the first originator and the first user; and in response to determining that the second digital transaction is associated with at least one of the first originator and the first user, storing the second data in the first container.

### BACKGROUND

An interest exists to share information without sharing personally identifiable information.

### SUMMARY

A growing concern exists with regards to the exposure of personal information, however, some level of information can be required in order to properly organize and communicate information. For example, a financial institution can require some information about an individual to ensure that the financial institution provides the correct account information back to the individual.

The concepts described herein provide a method of conveying information through methods that minimize the exposure of an individual's personally identifiable information. For example, through the use of tokens appended to transactions, a system can cluster the similar transactions and tokens together. Over time, the system can determine an anonymized identities associated with the use of the clustered tokens and transactions. This process can occur among multiple entities such as banks, online retailers, budgeting applications, or other appropriate entities.

In this example, an individual can make a purchase using a credit card, a first originator, the business, then sends a first token appended to the last four digits of the credit card to the system described. The system can store the use of that first token and last four digits within a storage container (e.g., a digital wallet). At the same time or at a later time, a second originator, the credit card issuer (e.g., the bank), can send a second token appended to the same last four digits of the credit card to the system. With sufficient contextual action data, the system can associate the first token with the second token within the same storage container without the use of personally identifiable information.

Systems can improve data security while enabling and enhancing access to the data and use of the data. For example, the system can then use the anonymized identities to discern characteristics and habits about the individual without the exposure of the individual's personal information. In some instances, the system and processes can utilize the data to identify trends, best practices, areas of improvement, advertising, market shifts, product preference, regional specific reactions, and other computational practices utilized to extract information from data sets, while maintaining personal privacy of users.

For the purposes of this application a person of reasonable skill in the art would understand that to minimize the exposure of an individual's personally identifiable information includes likely minimizing, substantially minimizing, eliminating, nearly eliminating, substantially eliminating, and likely eliminating the exposure of an individual's personally identifiable information.

In general, one aspect of the subject matter described in this specification can be embodied in methods that include the actions of receiving first data representing a first digital transaction, the first data including: a first token associated with a first originator and a first user; and a first character string associated with the first user; generating a first container represented by a second token, the first container being associated with the first originator and the first user; storing the first data in the first container; receiving second data representing a second digital transaction; determining that the second digital transaction is associated with at least one of the group consisting of the first originator and the first user; and in response to determining that the second digital transaction is associated with at least one of the group consisting of the first originator and the first user, storing the second data in the first container.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, determining that the second digital transaction is associated with the first originator comprises determining that the second data includes the first token.

In some implementations, determining that the second digital transaction is associated with the first user comprises determining that the second data includes the first character string.

In some implementations, determining that the second digital transaction is associated with at least one of the group consisting of the first originator and the first user comprises determining that the second digital transaction is associated with the first originator and the first user.

In some implementations, generating the first container in response to determining, based on the first data, that no containers of a set of containers are associated with the first token or the first character string.

In some implementations, generating the first container in response to determining, based on the first data, that no containers of a set of containers are associated with the first token and the first character string.

In some implementations, receiving third data representing a third digital transaction, the third data including: a second token associated with a second originator of the digital transaction and a user; and a second character string associated with the user; determining that no containers of a set of containers are associated with the second token and the second character string; and in response, generating a second container represented by a third token, the second container being associated with the second originator and the user.

In some implementations, the user is the first user.

In some implementations, the first data and the second data are received from a same entity.

In some implementations, the first data and the second data are received from different entities.

In some implementations, determining that the second digital transaction is associated with at least one of the group consisting of the first originator and the first user based on a probabilistic association between the second data and the first data.

In some implementations, the second token is a unique identifier for the first container.

In some implementations, the first container comprises an electronic storage container.

In some implementations, the first data includes at least one of the group consisting of: a date of the first digital transaction; a time of the first digital transaction; an amount of the first digital transaction; a location of the first digital transaction.

In some implementations, the first digital transaction comprises a digital transaction of tender.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example system that includes an electronic container and the components therein.

FIG. 2 is an example process of the system receiving and associating a newly received tender with a container.

FIG. 3a is an example system with storage containers.

FIG. 3b is an example of the storage containers of FIG. 3a being associated together through information from a third container

FIG. 4 is a flow chart of an example process of transaction correlation with transactional data.

FIG. 5 is a block diagram of a computing system that can be used in connection with computer-implemented methods described in this specification.

Like reference numbers and designations in the various drawings indicate like elements.

### DETAILED DESCRIPTION

The transfer of information data over networks is vital in a modern technological world, but becoming more dangerous with the risk of the exposure of data, for example personally identifiable information (PII), proprietary information, and any other form of data desirable of protection. Users are becoming increasingly aware of their personal risk when sending and receiving information data over a network.

For this reason, there exists a need for the transfer of this information that is de-identified with a user or without associating a user's PII. In this way organizations, programs, enterprises, and any other computer implemented function can continue to carry out operations that require information data to be exchanged without exposing users to risks such as identity theft, unauthorized account access, profiling, fishing, and other cyber security threats.

This disclosure describes methods by which a user's information data can transfer from the user to an endpoint system and between systems. This method can transfer the information data without including a user's PII or in a method that is de-identified with a user. Generally, this method is carried out through the use of electronic storage container (e.g., electronic wallets) to store, categorize, associate, and otherwise analyze anonymized data through the use of tokens and other transactional data.

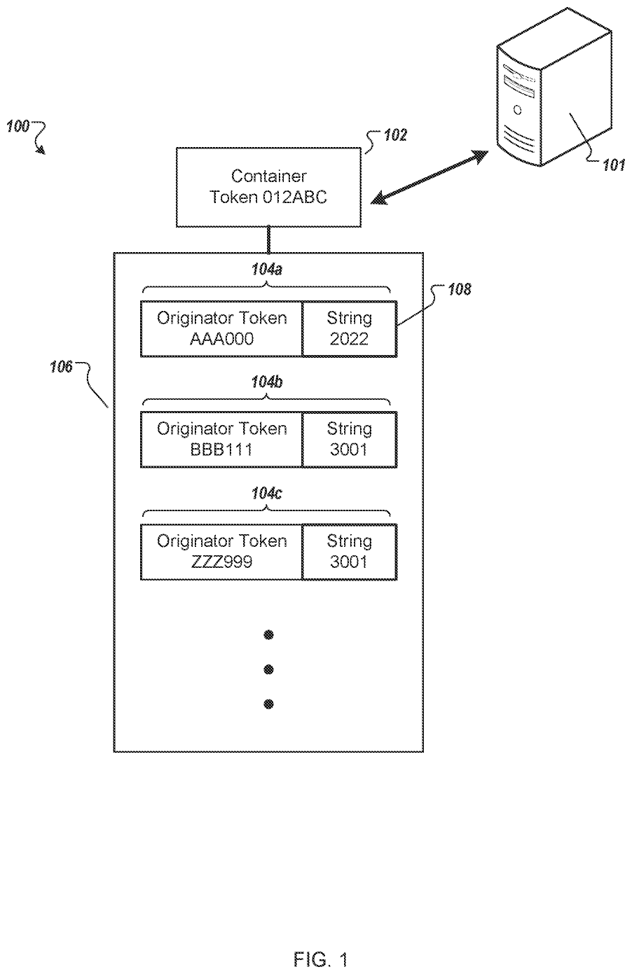

FIG. 1 is an example system 100 that includes an electronic container 102 and the components therein. The container 102 can contain one or more tenders 104. Each tender includes an originator user token 106 and a string 108. A tender is a form of payment. The system 100 includes a server 101 in communication with the container 102.

The container 102 can be a software based storage container such as a digital wallet or digital storage device. The container 102 acts to store digital information in a singular location and can link to other containers. For example, a container 102 can be a digital wallet that can store financial information such as credit cards. The container 102 can be a hardware based storage container such as a removable storage media, hard drive, or server based storage. The container 102 can be a combination of software based storage and hardware bases storage. The container 102 can include encryption elements protecting the contents.

The container 102 can include tokens. For example, container 102 includes token 012ABC. The token can identify the container 102 and distinguishes it from other containers. The token can be a digital hash, randomly generated character strings, algorithmically generated character strings, or any combination thereof. The token associated with a container 102 can remain persistent to that container. For instance, the container 102 can include token 012ABC that identifies a digital wallet that further contains various transactional components that are associated with the digital wallet. A container 102 can include or make reference to one or more tokens or one or more containers.

The container 102 can include one or more tenders 104a-c. A tender 104 can include an originator user token 106 and a character string 108. For example, tender 104a includes originator user token AAA000 and character string 2022. A tender 104 can represent an organizational identity as well as an individual identity. For example, a tender 104a can have the organizational identity of the originator's identification of an account through the originator user token AAA000 and the individual identity of the character string 2022. In this example, the originator user token AAA000 can represent both an account at the originator and provide data about the entity sending the information, such as a bank, retailer, or mobile application.

In some instances, the container 102 receives contributions from multiple entities that each associate to their originator user tokens with the container 102. For example, a business, a merchant, and a bank can all send tenders that include originator user tokens unique to an individual. In this example, the system can recognize attributes of the tenders such as transactional data, to determine all the tenders belong in the same container. In this example, the system stores the tenders in a single wallet that can associate some attributes of the individual without revealing private data. In this example, whenever the entities communicate with the container, they communicate with the same originator user token, but may use a different string. For example, the same originator can send two different tenders representing a single customer at two different times. The two different tenders would have the same originator user token, but could have different strings representing different methods of payment. It is the two different tenders with some shared characteristics that can allow the system to associate the tenders into a container.

An originator user token 106 can represent a persistent account associated with the originator of the information. For example, a digital wallet containing tenders 104a-c can include a first tender 104a with an originator user token AAA000 that represents a user account at a bank and character string 108 that represents the last for digits of a credit card from the same bank. Originator user tokens can originate from systems integrated to or participating in the system. For example, an issuer of an originator user token can be applications, software, banking institutions, retailers, marketers, clubs, businesses, or any combination thereof. The originator user token 106 can represent an organizational identity, an individual within that organization, or a combination thereof. For example, the originator user token AAA000 can represent a specific customer at a grocery store and the string 2022 the last four digits of the credit card of that customer.

In some instances, the originator user token 106 is identified by the system by recognizing the sender of the token. In these instances, the originator user token represents a user account held by the originator and associated with a user. For example, the system can recognize the sender of a token as a bank and the originator user token can be associated with an account at the bank. In other instances, the originator user token can have identifying characteristics such that the token itself identifies the sender. For example, the system can recognize the sender of the token from a portion of the originator user token, such as the first three characters.

Character strings 108 can represent a persistent object. For example, a tender 104 can include a character string 108 that represents the last four digits of a credit card. The character string can be representative of any endpoint device such as a credit card, mobile payment application, crypto currency wallet, gift card, debit card, ATM card, or any combination thereof.

The use of an originator user token 106 with different strings 108 can provide action based contextual data to associate tenders 104 with other tenders or with other containers 102. For example, a customer at grocery store can use a customer rewards card that can allow the grocery store systems to associate the customer with that customer's unique originator user token AAA000 and a credit card that can allow the grocery stores system to associate the last four digits of the customers card, 2022, to the originator token. The next day, the customer can make another purchase using the same customer rewards card, which associates with originator user token AAA000 and a new credit card with the last for digits 1011. The use of a common originator user token and different strings provides the contextual information that can provide associations between tenders, containers, or a combination thereof.

In some embodiments the originator user token 106 can be unique to the originator and the character string 108. For example, an originator such as a grocery store can determine through the use of a discount card, frequent shopper card, telephone number, or similar method the identity of the customer. Using the identity of the customer, the grocery store system can assign a unique originator user token to the customer. The unique originator user token can uniquely identify the grocery store, the customer, or a combination thereof. The unique originator user token can be associated with the character string to create a tender that does not contain any PII of the customer.

In some embodiments the tenders 104a-c can have similar information. For example, tenders 104b and 104c contain the same character strings 3001, but different originator tokens BBB111 and ZZZ999 respectively. These instances allow for the correlation of information between the two tenders 104b and 104c. For example, this can represent the use of the same credit card, with the last four digits of 3001. In this example, the tender 104b is a report of the use of the credit card ending in 3001 from the credit card company with the originator user token BBB111. In this example, the tender 104c is a report of the use of the credit card ending in 3001 from the retailer where the card was used with the originator user token ZZZ999. Because of the shared context, the two tenders 104b and 104c are associated under a single container 102.

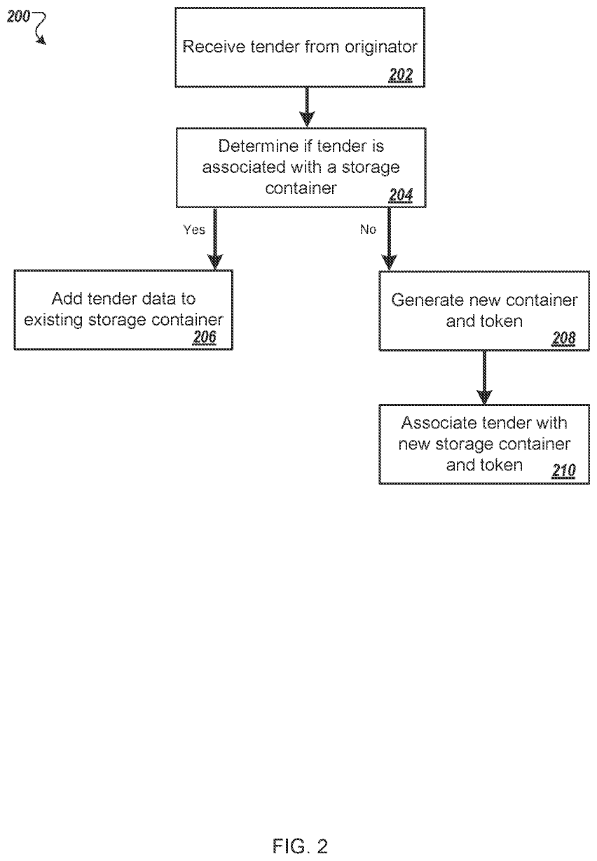

FIG. 2 is an example process 200 of receiving and associating a newly received tender with a container. The process 200 can be performed by the system 100, e.g., by the server 101 of the system 100. For example, when the server 101 receives a new instance of a tender from an originator such as a retailer, the server 101 can determine whether the tender matches a previously used tender or if the tender is unrecognized and requires the generation of a new container (e.g., wallet) to store the newly received tender.

The process can start with the receipt of a new tender from an originator 202. An originator can be an organization, business, financial institution, online marketplace, retailer, store, restaurant, or any other venue for commerce. Each originator can have a specific originator user token unique to the originator. In some instances, the originator tokens are generated by a third party, a supervising entity, or the originator themselves. In some instances the tokens are created and assigned to the originators by a supervising entity. Originators can send tenders to the server 101, where a tender is the combination of the originator's unique token and a character string. In some examples, the character string can represent a credit card number, hashed identifying numbers, unique numbers identifying a digital payment account, bank account numbers, or any other identifying number or character strings for a transaction account.

The process can determine whether the tender currently associates or has previously associated with a container 204. The server 101 can analyze the tender to include the originator user token and the string to determine whether the token, a part of the token, or any other data associates the newly received tender with any current container. For example, the server 101 can recognize a tender that is a combination of a bank token and the last four digits of a credit card number. In this example, a tender that includes a token that has not previously been seen by the system could be considered a new tender even with a repeated string. In this example, the system could create a new container for this new tender. In some examples, the system can recognize the token within the tender and associate that tender with an existing container even if the string is different.

If the process determines that the tender currently associates or previously associated with a container, the received tender and any data therein is associated with the existing previously associated container 206. For example, the server 101 can recognize the tender as frequently used at the originator, such as a grocery store, and the tender is known to be associated with a wallet. With the known association of the newly received tender with the previously used tender, the server 101 can either add the tender to the container based on the association or associate any new data from the newly received tender to the container in which the tender is assigned if that data does not already exist in the container.

If the process determines that the tender's token matches to (or is associated with) a known container, but the token's string is not previously associated with a container, the server 101 can determine which container matches the tender's token and add the tender with the new string to the existing container 208 associated with the tender's token. In this example, the container 208 now stores two tenders that share the same token, but different strings. For instance, the server 101 can receive a new tender that contains a known originator token, but a new string. In this instance, the new string could be a new credit card and the known originator user token may be a frequent shopper account associate with the owner of the credit card. This instance, might be a purchase at a grocery store with a new credit card. The tender generated in this instance would include a known originator user token and a new string. This newly received tender is not recognized by the server 101 as being associated with any current container. After it is determined that the newly received tender, is not associated with a container, the server 101 can generate a new container token and a new container.

If the process determines that both portions of the tender are not currently associate with or has not previously been associated with a container, the server 101 can generate a new container token and container 208. For instance, the server 101 can receive a new tender that contains a known originator token, but a new string. For instance, a purchase can occur at a grocery store with a credit card. The tender received from the vender can in this instance contain both a new originator user token and a new string. This newly received tender is not recognized by the server 101 as being associated with any current container. After it is determined that the newly received tender, is not associated with a container, the server 101 can generate a new container token and a new container.

The process can then associate the newly received tender and any data therein with the newly created container and container token 210. Based on the determination that the newly received tender is not associated with a current container and the newly created container token and container, the server 101 can associate the newly received tender with the newly created container token and container. For example, the grocery store reports a tender that is a combination of the known originator user token for the grocery store and the last for digits of a new credit card. The server 101 receives the tender and determines it is not associated with a current container or container token and creates a new container token and container for the newly received tender.

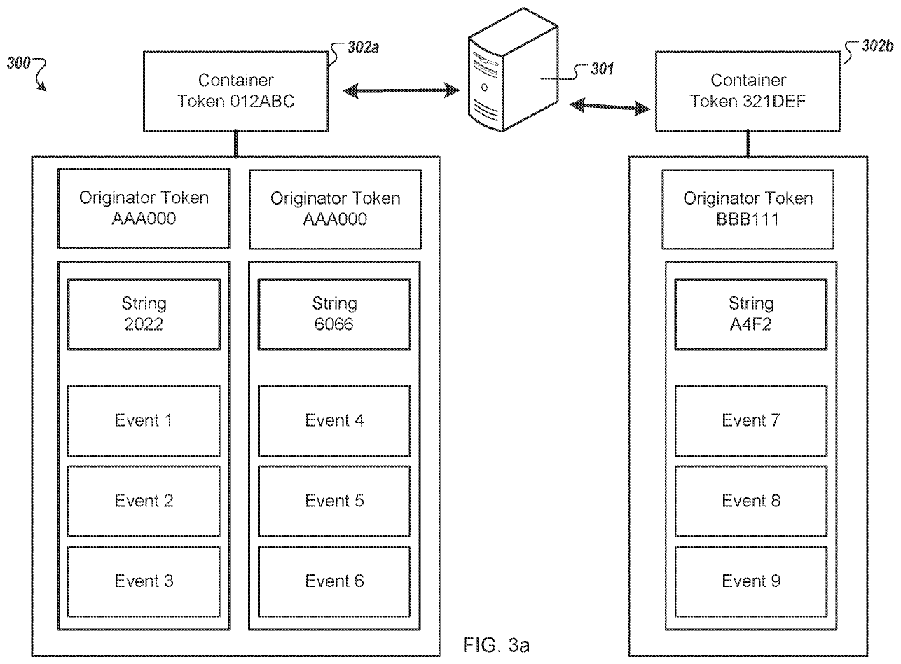

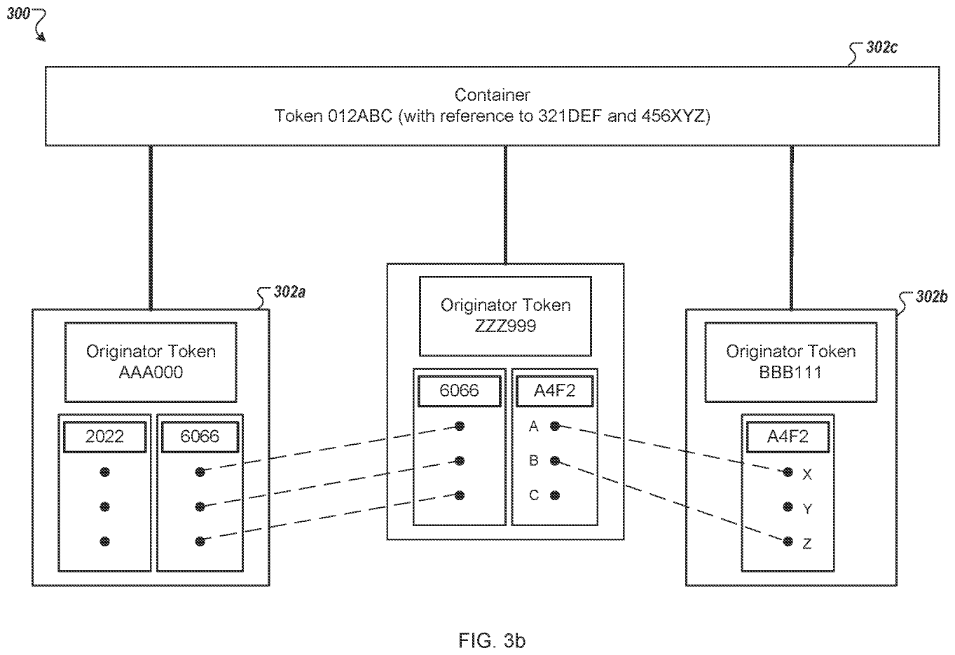

FIG. 3a is an example system 300 with containers 302a and 302b. The system 300 includes a server 301 in communication with the containers 302a, 302b.

In the example system 300, both containers 302a, 302b hold information about a singular entity. As shown in FIG. 3a, there is initially no correlation between the two containers. For example, containers 302a-b are each digital wallets containing payment options, such as credit cards, debit cards, gift cards, mobile payment accounts (e.g., PayPal, Apple Pay, Samsung Pay, Google Pay) for a single individual and events such as transactions, returns, pending or otherwise. The events can include transaction data that can include, but is not limited to the parties involved, the date the transaction occurred, the area, location, or place the transaction occurred, the transaction amount, details of the receipt, or other unique and applicable characteristics of the transaction.

Container 302a can contain information from one or more originators each with a single persistent token. For instance, container 302a can contain information from a bank with originator user token AAA000. In this instance, the information associated within container 302a are two tenders, a first comprising the originator user token AAA000 and the string 2022 and a second comprising the same originator user token and the string 6066. In this instance, the string 2022 can represent the last four digits of a credit card and the string 6066 can represent the last four digits of a debit card.

Container 302a can contain event data associated with the use of the tenders. For example container 302a can contain a first tender with originator user token AAA000 and string 2022. Associated with the tender can be several events. For example, container 302a can be a digital wallet with a tender comprising a bank originator user token AAA000 and the last four digits of a credit card 2022. In this example, the tender can have data associated with it representing one or more transactions of the credit card ending in 2022. In this example, the server 301 can receive tenders from the venders at which this credit card ending in 2022 was used, each tender from a retailer can include the retailer's originator user token and the same last four credit card digits 2022.

Container 302b can contain similar information to container 302a, but contains a different token than container 302a. Similar to container 302a the information under this container originates from a one or more originators each with a single persistent token. For instance, container 302b can contain information from a digital payment service with originator user token BBB111. In this instance, the information associated within container 302b is one tender comprising the originator user token BBB111 and the string A4F2. In this instance, the string A4F2 can represent the last four alphanumeric characters of a digital payment account (e.g., PayPal, Apple Pay, Samsung Pay, Google Pay) or a cryptocurrency account and/or wallet.

In the example of system 300, the credit card ending in 2022, the debit card 6066, and the digital payment account ending in A4F2 can all belong to a single individual. However, at this point, the information necessary to reveal the association of these accounts has not been provided to the server 301.

FIG. 3b is an example of the storage containers from FIG. 3a being associated together through information from a third container. For example, a user can download an application on a computer device such as a desktop, laptop, smartphone or a combination thereof that allows the user to organize payment methods and budget personal expenses. The application that organizes the payment information and personal budget can share that information with the server 301. The server 301 can use the shared information to associate the tenders added to the mobile application with the tenders previously identified and stored under separate containers.

The server 301 can use information from different containers in order to associate containers and tenders together through probabilistic matching of shared events among different event data associated with the tenders. For example, an individual can download a digital transaction application such as a common digital payment application on a mobile device and associate credit and debit cards with the digital payment application. In this example, the digital payment application can send tenders to the server 301 that include a unique originator user token of the digital payment application and the last four digits of the credit cards associated with the digital payment account.

In this example, the server 301 can utilize the event history of different tenders and compare the event history to other tenders in other containers and perform methods of determining a match between the data. For instance, the transaction history of a credit card, such as the credit card statement from a bank, can have matched transactions with a vender's statements of the use of that credit card with the vender. Probabilistic matching can associate the tender provided from the bank with the tender provided by the venue through the event data.

For instance, container 302c can be associated with a downloaded financial application that includes the ability to perform mobile payments. The container 302c can include token 456XYZ and include tenders from an originator with originator user token ZZZ999. The tenders included in container 302c can include a first tender with originator user token ZZZ999 and the string 6066 and a second token with originator user token ZZZ999 and the string A4F2. With the information provided from the container 302c and the associated tenders within the container, the server 301 can associate the tender from container 302a that includes the originator user token AAA000 and the string 6066 is the same physical payment method as the token from container 302c with the originator user token ZZZ999 and the string 6066. With this information, the server 301 can associate container 302a with token 012ABC with container 302c with token 456XYZ. Likewise, the server 301 can use information from the container 302c and a first tender that includes the originator user token BBB111 and the string A4F2 and can associate that first tender with a second tender from container 302c and the tender that includes originator user token ZZZ999 and the string A4F2. With the associated first and second tenders, the server 301 can associate container 302b with the combined containers of 302a and 302c to create a singular container that is associated with three tokens: 012ABC, 321DEF, and 456XYZ.

In some embodiments, the received data from originator user token ZZZ999 and string A4F2 does not directly correlate to the received data from originator user token BBB111 and string A4F2. For instance, even though both originator tokens have the same string A4F2, the events can be organized differently. In this instance, originator user token ZZZ999 categorizes the data as A, B, C and originator user token BBB111 categorizes the data as X, Y, Z. The FIG. 3b depicts straight lines from A to X, but the correlation of data can be more complicated such that various data elements are correlated in various configurations. For example, if originator user token ZZZ999 and string A4F2 represents a financial institution and a credit card, the events can occur across various entities such as different merchants, institutions, or individuals. In this example, if originator user token BBB111 and string A4F2 represents a specific institution and the use of that credit card at that particular institution. In this example, the data reported by the specific institution can include only a portion of the total the data of that can be reported by the financial institution.

In some embodiments, the events are stored separately from container 302. For instance, the events can be used to sort of store information across containers, but not be stored with that same information. In this instance, the events can be stored elsewhere and retrieved at a later time or compared with containers 302 based on other criteria. For example, the system can compare the received tenders and events, use the events to sort the tenders into an appropriate first set of containers and store the events into a second set of containers or in an entirely separate location. This process can further protect the data from compromise while allowing the tenders and events to later be audited together or separately.

In some embodiments, the matching of events can allow for the organization of tenders into containers. For example, a bank and a retailer can separately report two different tenders and event data. The bank tender could include a bank token relating to the customer account such as AAA000 and the string of 2022. Here, the token could refer to the customers account at the bank and the string could refer to the last four digits of the customer's credit card. The merchant tender could include a merchant token relating to the customer's frequent shopper account such as BBB111 and could include the same string 2022 showing that the customer likely used the same credit card ending in 2022. Both the bank and the merchant may send event data such as the purchase amount, location, time, or other relevant data. The system can use the tender from both the bank and the merchant as well as the event data from the bank and the merchant to match the tenders to the same container. After the matching is complete, the system can store the event data elsewhere.

In some embodiments, the two tenders are matched without relying on a matching token or string, but with probabilistic determination. For example, a bank and a retailer can separately report two different tenders and event data and use the event data to probabilistically determine that each entity's tender represents the same or related tenders. The bank tender could include a bank token relating to the customer account and a string. The merchant tender could include a merchant token relating to the customer's frequent shopper account and a string. Both the bank and the merchant may send event data such as the purchase amount, location, time, or other relevant data. The system can use the tender from each entity as well as the event data from each entity to probabilistically determine a match between the tenders and store them in the same container. The probabilistic determination may require accruing data over a period of time to develop trends within the data. After the matching is complete, the system can store the event data elsewhere. This configuration is useful when the strings within the tenders do not uniquely identify an individual, or an entity does not provide a string with the tender, or an entity reuses the same string repeatedly. This is also useful when credit card companies use the same last four digits among credit cards and distinguish between card holders in other ways.

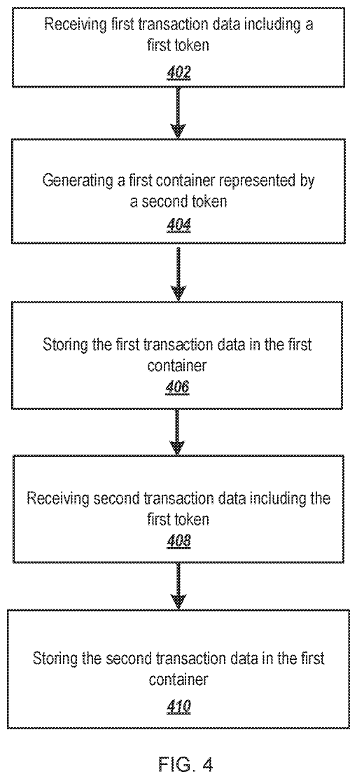

FIG. 4 is a flow chart of an example process 400 of transaction correlation with transactional data. The process 400 can be performed, for example, by the system 100 or the system 300.

The process 400 includes receiving first transaction data including a first token (402), generating a first container represented by a second token (404), storing the first transaction data in the first container (406), receiving second transaction data including the first token (508), and storing the second transaction data in the first container (410).

Receiving transaction data including a first token (402) can include any appropriate data received from a first entity. The data can be in any appropriate format or context. For example, a first entity can be a retailer that can transmit transaction information to the system. The data in this example can be information about the transaction such as purchase amount, time, location, or any combination of appropriate data types or fields.

Generating a first container represented by a second token (406) can involve a variety of processes and determinations. For example, the system can make a determination that the first transaction data from the first entity warrants a newly generated token and in response generate a token under which the first data can be stored. In some examples, the second token generated by the system can link to, represent, or associate with a digital wallet or storage container under which future data that is received from various entities but is associated with the same first transaction data can be stored.

In some examples, the system can make determinations that the received data does not require the creation of a new container. For example, the system can receive transaction data from the first entity and determine that the transaction data from the first entity matches previously identified transaction data that the system previously created a container and token for. Instead of creating a new container and token for the newly received data, the system can associate the newly received data from the first entity with the previously received data from the first entity for which a token was already created.

The system stores the first transaction data in the first container (406). The system receives second transaction data (408) which can include similar or different data formats as the first transaction data. In some instances, the second transaction data entity can include more or less data than the first transaction data. The second transaction data can be received from the same entity or from a different entity than the first transaction data. In some examples, the system can receive first transaction data and second transaction data from the same entity. In these cases, the system can determine to create a first and second token for the respective first and second data received from the first entity. In some examples, the second entity can be a bank sending transaction data about the same transaction the first entity reported. The second data can include data about the transaction from the bank's perspective, such as, but not limited to the last four of the credit card, the transaction amount, location, time, or any appropriate data.

In some examples, the system can determine that two tokens should be associated together and in response, associated the first and second tokens together. For example, the generated first and second tokens can later be determined to be uses of the same credit card reported by the first entity, e.g., a retailer, and reported by the second entity, e.g., a bank. In these examples, the system can associate the first and second tokens together and thus store all the data associated with the first and second tokens in a singular location. Thus, the system can store the second transaction data in the first container (410).

In some examples, the system can determine that two tokens should no longer be associated together and in response disassociate the two tokens. The data previously jointly stored under both tokens, can then be split back between the two tokens. The first token can maintain the first data associated with the first token, and the second token can maintain the second data associated with the second token.

In some examples, the data received by the system from the entities is in the form of a tender or the combination of a unique entity token and the last four digits of a credit card of a user. In some examples the tender includes a token that both uniquely identifies the entity sending the information and is uniquely associated with the last four digits of the credit card used. For example, a user in the store can use a frequent shopper card with the user's credit card. In this example, the frequent shopper card provides the unique token associated with both the entity, e.g., retailer, and the user of the credit card and frequent shopper card.

In some examples, the system includes data that is entirely deidentified. Each piece of information can be matched based on the data's relation to other data and without identifying PII of any users associated with the data. Within the system the organization and association of the data can occur through the use of tokens. If the data is removed from the system and integrated with data from an originator, the originator can potentially identify or associate users with tokens that the originator previously issued. For example, if the system sends data about the a container that includes a retailer's originator token, back to the originator, then the originator can use a separate system to then associate the originators token with a specific user. In this example, the retailer has the potential to acquire additional information from the container and associate it with one of their customers. In some instances, this two way communication between the system and the originator is possible. In some instances, the communication between the system and the originator is one-way from the originator to the system so that the re-association of data and the exposure of PI is more likely prevented.

The order of steps in the processes 400 described above is illustrative only, and can be performed in different orders. In some implementations, the processes 400 can include additional steps, fewer steps, or some of the steps can be divided into multiple steps.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the system that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used.

A number of implementations have been described. Nevertheless, it will be understood that various modifications may be made without departing from the spirit and scope of the disclosure. For example, various forms of the flows shown above may be used, with steps re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

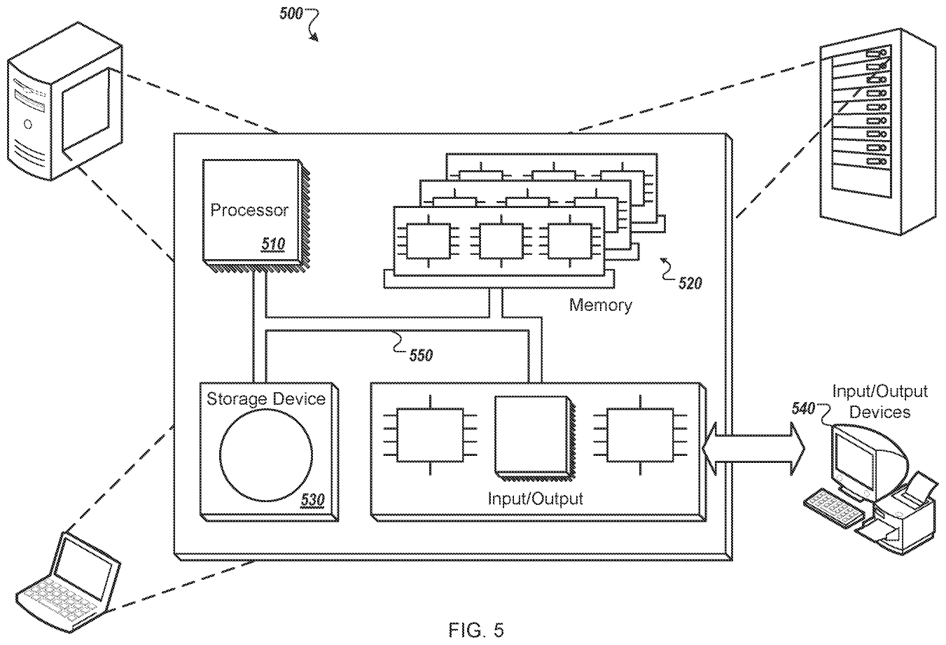

An example of one such type of computer is shown in FIG. 5, which shows a schematic diagram of a computer system 500. The system 500 can be used for the operations described in association with any of the computer-implemented methods described previously, according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular implementations of the invention have been described. Other implementations are within the scope of the following claims. For example, the steps recited in the claims, described in the specification, or depicted in the figures can be performed in a different order and still achieve desirable results. In some cases, multitasking and parallel processing may be advantageous.

What is claimed is:

1. A computer-implemented method comprising:
receiving first data representing a first digital transaction, the first data including:
a first token associated with a first originator and a first user; and
a first character string associated with the first user;
generating a first container represented by a second token, the first container being associated with the first originator and the first user;
storing the first data in the first container;
receiving second data representing a second digital transaction;
determining that the second digital transaction is associated with at least one of the group consisting of the first originator and the first user; and
in response to determining that the second digital transaction is associated with at least one of the group consisting of the first originator and the first user, storing the second data in the first container.

2. The method of claim 1, wherein determining that the second digital transaction is associated with the first originator comprises determining that the second data includes the first token.

3. The method of claim 1, wherein determining that the second digital transaction is associated with the first user comprises determining that the second data includes the first character string.

4. The method of claim 1, wherein determining that the second digital transaction is associated with at least one of the group consisting of the first originator and the first user comprises determining that the second digital transaction is associated with the first originator and the first user.

5. The method of claim 1, comprising generating the first container in response to determining, based on the first data, that no containers of a set of containers are associated with the first token or the first character string.

6. The method of claim 1, comprising generating the first container in response to determining, based on the first data, that no containers of a set of containers are associated with the first token and the first character string.

7. The method of claim 1, comprising:
receiving third data representing a third digital transaction, the third data including:
a second token associated with a second originator of the digital transaction and a user; and
a second character string associated with the user;
determining that no containers of a set of containers are associated with the second token and the second character string; and
in response, generating a second container represented by a third token, the second container being associated with the second originator and the user.

8. The method of claim 7, wherein the user is the first user.

9. The method of claim 1, wherein the first data and the second data are received from a same entity.

10. The method of claim 1, wherein the first data and the second data are received from different entities.

11. The method of claim 1, comprising determining that the second digital transaction is associated with at least one of the group consisting of the first originator and the first user based on a probabilistic association between the second data and the first data.

12. The method of claim 1, wherein the second token is a unique identifier for the first container.

13. The method of claim 1, wherein the first container comprises an electronic storage container.

14. The method of claim 1, wherein the first data includes at least one of the group consisting of:
a date of the first digital transaction;
a time of the first digital transaction;
an amount of the first digital transaction;
a location of the first digital transaction.

15. The method of claim 1, wherein the first digital transaction comprises a digital transaction of tender.

16. A system comprising one or more computers and one or more storage devices on which are stored instructions that are operable, when executed by the one or more computers, to cause the one or more computers to perform operations comprising:
receiving first data representing a first digital transaction, the first data including:
a first token associated with a first originator and a first user of the digital transaction; and
a first character string associated with the first user;
generating a first container represented by a second token, the first container being associated with the first originator and the first user;
storing the first data in the first container;
receiving second data representing a second digital transaction;
determining that the second digital transaction is associated with at least one of the group consisting of the first originator and the first user; and
in response to determining that the second digital transaction is associated with at least one of the group consisting of the first originator and the first user, storing the second data in the first container.

17. The system of claim 16, the operations comprising:
receiving third data representing a third digital transaction, the third data including:
a second token associated with a second originator of the digital transaction and a user; and
a second character string associated with the user;
determining that no containers of a set of containers are associated with the second token and the second character string; and
in response, generating a second container represented by a third token, the second container being associated with the second originator and the user.

18. The system of claim 16, wherein determining that the second digital transaction is associated with at least one of the group consisting of the first originator and the first user comprises determining that the second digital transaction is associated with the first originator and the first user.

19. One or more non-transitory computer storage media encoded with instructions that, when executed by one or more computers, cause the one or more computers to perform operations comprising:
receiving first data representing a first digital transaction, the first data including:
a first token associated with a first originator of the digital transaction; and
a first character string associated with a first user;
generating a first container represented by a second token, the first container being associated with the first originator and the first user;
storing the first data in the first container;
receiving second data representing a second digital transaction;
determining that the second digital transaction is associated with at least one of the group consisting of the first originator and the first user; and
in response to determining that the second digital transaction is associated with at least one of the group consisting of the first originator and the first user, storing the second data in the first container.

20. The computer storage media of claim 19, the operations comprising:
receiving third data representing a third digital transaction, the third data including:
a second token associated with a second originator of the digital transaction and a user; and
a second character string associated with the user;
determining that no containers of a set of containers are associated with the second token and the second character string; and
in response, generating a second container represented by a third token, the second container being associated with the second originator and the user.
